(19) United States
(12) Patent Application Publication
(10) Pub. No.: US 2023/0298104 A1
(43) Pub. Date: Sep. 21, 2023

(54) SYSTEMS AND METHODS FOR SETTLING DISPUTED CLAIMS

(71) Applicant: Change Healthcare Holdings, LLC, Nashville, TN (US)

(72) Inventor: Benjamin Joseph Diatto, Aledo, TX (US)

(21) Appl. No.: 17/698,098

(22) Filed: Mar. 18, 2022

(51) Int. Cl. G06Q 40/08; G06Q 50/18

(52) U.S. Cl. CPC G06Q 40/08; G06Q 50/188

(57) ABSTRACT

Systems and methods for settling disputed claims and avoiding arbitration are provided. A set of settled medical claims is used to train a model to predict the settlement amount of a medical claims based on a variety of attributes of the claim. Later, when an insurance payor disputes a claim sent by a medical provider, the model is used to predict a settlement amount based on the attributes of the disputed claim. This predicted settlement amount is then sent to the payor and the medical provider as a proposed settlement amount for the disputed claim in a user interface. The medical provider and payor can either accept the proposed settlement amount or can provide a counter settlement amount through the user interface. Once both parties agree on the settlement amount, the disputed claim is settled and arbitration is avoided.

### BACKGROUND

The No Surprises Act (NSA) mandates that billing disputes related to a medical claim between a medical provider and a payor move be settled through arbitration. According to the NSA, when a medical claim is disputed a 30-day negotiation period begins where the payor and the medical provider may attempt to resolve the dispute. At the end of the 30-day period, either the medical provider or the payor may initiate the arbitration process. During the arbitration process, each party submits their offer for payment along with supporting documentation. The arbitrator then selects one of the offers for payment, and the losing party must pay the arbitration fees.

As may be appreciated, there are many drawbacks associated with the arbitration process mandated by the NSA. First, the 30-day negotiation period is long and delays receipt of payment for the medical claim. Second, arbitration can be expensive and unpredictable for both parties. Accordingly, there is a need to settle disputed medical claims quickly and avoid the arbitration process of the NSA.

### SUMMARY

In an embodiment, systems and methods for settling disputed claims and avoiding arbitration are provided. A set of settled medical claims is used to train a model to predict the settlement amount of a medical claim based on a variety of attributes of the claim such as the medical procedure or service associated with the of medical claim, whether the medical claim is an in-network or out of network claim, and the location associated with the medical claim. Later, when an insurance payor disputes a claim sent by a medical provider, the model is used to predict a settlement amount based on the attributes of the disputed claim. This predicted settlement amount is then sent to the payor and the medical provider as a proposed settlement amount for the disputed claim in a user interface. The medical provider and payor can either accept the proposed settlement amount or can provide a counter settlement amount through the user interface. Once both parties agree on the settlement amount, the disputed claim is settled and arbitration is avoided.

The systems and methods described herein provide the following advantages. First, by proactively generating a proposed settlement amount for a disputed claim, the likelihood of the disputed claim going to arbitration is greatly reduced. Second, the ability for the payor and providers to create and submit counteroffers using a user interface increases communication between the payor and the provider, which may further reduce the likelihood of the disputed claim going to arbitration. Third, by identifying claims that may be disputed before they are submitted, the number of disputed claims for a medical provider are further reduced.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying figures, which are incorporated herein and form part of the specification, illustrate an arbitration due to disputed claims prevention system and method. Together with the description, the figures further serve to explain the principles of the prevention system and method system and method described herein and thereby enable a person skilled in the pertinent art to make and use the disputed claims prevention system and method.

FIG. 1 is an example environment for settling disputed claims prior to arbitration;

FIG. 2 is an illustration of an example method for training a model to predict the settlement amount for claims;

FIG. 3 is an illustration of an example method for alerting a medical provider when a submitted claim has a requested payment amount that exceeds a predicted amount;

FIG. 4 is an illustration of an example method for settling a disputed claim; and

FIG. 5 shows an exemplary computing environment in which example embodiments and aspects may be implemented.

### DETAILED DESCRIPTION

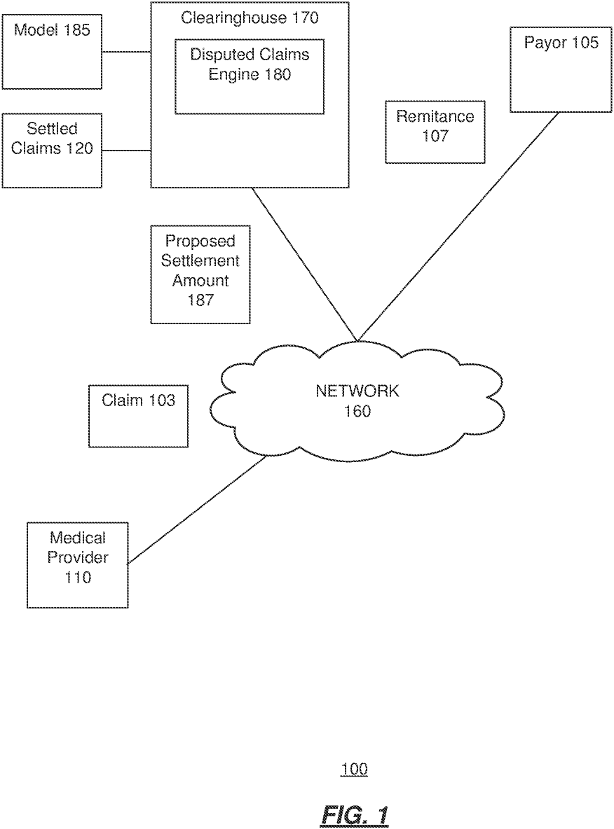

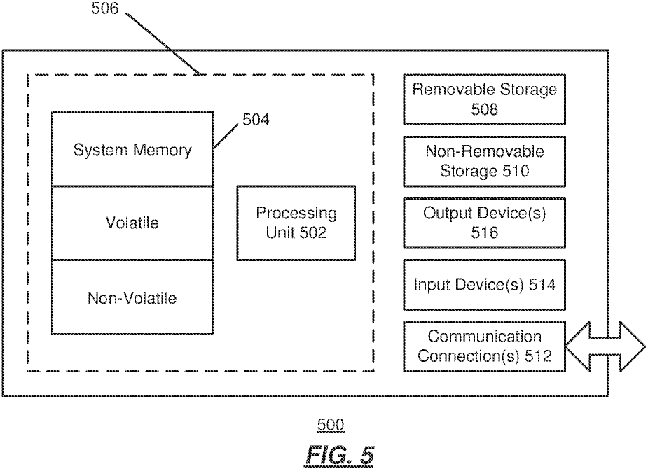

FIG. 1 is an example environment 100 for settling disputed claims prior to arbitration. As shown, the environment 100 may include a clearinghouse 170, one or more medical providers 110, and one or more payors 105 in communication through a network 160. The network 160 may include a combination of private networks (e.g., LANs) and public networks (e.g., the Internet). Each of the clearinghouse 170, the medical provider 110, and the payor 105 may use, or may be partially implemented by, one or more general purpose computing devices such as the computing device 500 illustrated in FIG. 5.

The clearinghouse 170 may be a medical claims clearinghouse 170 and may receive claims 103 for medical services rendered by medical providers 110 to patients 140. The clearinghouse 170 may then submit each received claim 103 to a corresponding payor 105 (e.g., insurance company or government entity), and may receive remittances 107, or claim payment decisions (e.g., denied, accepted, accepted at some level) from the payors 105 for the claims 103. The clearinghouse 170 may further facilitate transfer of the remittances 107 to the medical providers 110.

A medical claim 103 may be associated with a requested payment amount, at least one medical provider 110, and at least one payor 105. Each medical claims 103 may be further associated with one or more attributes that described the claim 103. Example attributes include an identifier or name of the medical procedure, medicine, or therapeutic associated with the claim 103, a date when the service associated with the claim was performed, a location of where the service associated with the claim was performed, demographic or other information associated with the patient corresponding to the claim 103, and whether or not the claim 103 is for an in-network or out-of-network provider 105.

The clearinghouse 170 may provide an application (cloud based or locally executed) through which payors 105 and providers 110 may use to submit, view, and manage their claims 103 and remittances 107. Medical providers 110 may use the application to submit claims 103 and to view the status of their claims 103. Example statuses indicate whether a claim 103 was received, whether a claim 103 was approved by a payor 105, and whether the claim 103 was settled. Depending on the embodiment, a claim 103 may be considered settled when a remittance 107 is received from the payor 103, or when payment is made to the provider 110.

Payors 105 may use the application to view the claims 103 that have been submitted to them and to approve claims 103 for payment. In addition, payors 105 may use the application to dispute a received claim 103.

For example, a payor 105 may dispute a claim 103 by providing an indication that they would like to dispute the claim 103 to the clearinghouse 170. The indication may be provided by a user interface element of the application (e.g., button). The payor 103 may be requested to enter or select a reason for the dispute. Where the claim 103 is being disputed due to the requested payment amount, the payor 103 may use the application to indicate that the claim 103 is being disputed due to the amount.

To facilitate the resolution and settlement of disputed claims 103 without using human arbitration, the clearinghouse 170 may further include a disputed claims engine 180. When an indication of a disputed claim 103 is received due to the requested payment amount, the disputed claims engine 180 may first determine a proposed settlement amount 187 that can be proposed to the payor 105 and the provider 110 to settle the claim 103. In some embodiments, the proposed settlement amount 187 may be based on feedback provided by the payor 105 disputing the claim 103. For example, the disputed claims engine 180 may ask, through the application or a user interface, for the payor 105 to indicate what amount of money they would be willing to pay to settle the claim 103. The disputed claims engine 180 may then use the indicated amount as the proposed settlement amount 187.

In some embodiments, the disputed claims engine 180 may determine the proposed settlement amount 187 as an average or combination of the amount requested by the medical provider 110 and the indicated amount provided by the payor 105. For example, if the provider 110 requested $1000 and the payor 105 indicated they would pay $500, the disputed claims engine 180 may determine the proposed settlement amount 187 as $750.

In some embodiments, to determine the proposed settlement amount 187, the disputed claims engine 180 may use a model 185 to predict what the claim 103 will settle for and may use the predicted amount as the proposed settlement amount 187. The model 185 may take as an input a claim 103 and the attributes associated with the claim 103, and may output the predicted settlement amount 187. The model 185 may be created by the disputed claims engine 180 or may be received from another entity. The model 185 may be a variety of model types including a machine learning model, a linear regression model, a neural network model, a logistic regression model, a decision tree model, a linear discriminant analysis model, and a naïve Bayes model. Other types of models 185 may be used.

In some embodiments, the model 185 may be trained using settled claims 120. The settled claims 120 may include claims 103 that were previously received and settled by the clearinghouse 170. The model 185 may be trained using the attributes associated with some or all of the claims 103 and the settlement amount associated with each claim 103. Any method for training a model 185 may be used.

In some embodiments, rather than use a model 185, the disputed claims engine 180 may determine predicted settlement amount 187 based on the settled claims 120. For example, when a claim 103 is disputed, the disputed claims engine 180 may determine claims 103 from the settled claims 120 that are similar to the disputed claim 103 based on attributes. The disputed claims engine 180 may then use the settlement amount from the most recent or most similar claim 103 as the predicted settlement amount 187. Alternatively, the the disputed claims engine 180 may use the average settlement amount from the similar claims 103 as the predicted settlement amount 187.

After determining the proposed settlement amount 187, the disputed claims engine 180 may present the proposed claim settlement amount 187. Depending on the embodiment, the disputed claims engine 180 may present the proposed settlement amount 187 to the payor 105 and the medical provider 110 in the application or user interface associated with the clearinghouse 170. If both the medical provider 110 and the payor 105 approve of the proposed settlement amount 187, the disputed claims engine 180 may settle the disputed claim 103 for the proposed settlement amount 187. Alternatively, the payor 105 may settle the disputed claim 103 for the proposed settlement amount 187 by paying the the proposed settlement amount 187 to the provider 110

In some embodiments, either or both of the medical provider 110 and the payor 105 may use the application or user interface to submit a counter settlement amount. The disputed claims engine 180 may then distribute the counter settlement amount to the medical provider 110 and the payor 105 as described above for the proposed settlement amount 187. The medical provider 110 and the payor 105 may then either approve the the counter settlement amount or may continue to propose new counter settlement amounts. Once both parties agree on a counter settlement amount, the disputed claims engine 180 (or payor 105) may settle the disputed claim 103 for the agreed on counter settlement amount.

In some embodiments, when a new claim 103 is submitted by a medical provider 110 to the clearinghouse 170, the disputed claims engine 180 may perform a “sanity check” on the requested payment amount associated with the new claim 103. The disputed claims engine 180 may perform the sanity check by using the model 185 to generate a predicted settlement amount for the new claim 103 based on the attributes associated with the new claim 103. If the predicted settlement amount is more than the request amount by some threshold percentage then the disputed claims engine 180 may alert the medical provider 110 that the claim 103 may be likely to be disputed. The disputed claims engine 180 may recommend that the medical provider 110 revise the requested amount to the predicted settlement amount.

For example, a medical provider 110 may submit a claim 103 for an out-of-network emergency room medical procedure with a requested payment amount of $150. The disputed claims engine 180 may use the model 185 to determine that the predicted settlement amount for the claim 103 is only $100. Because the requested payment amount is 50% greater than the predicted payment amount, the disputed claims engine 180 may alert the medical provider 110 that the requested amount is 50% greater than the predicted amount, and may suggest that the medical provider 110 revise the requested amount to $100.

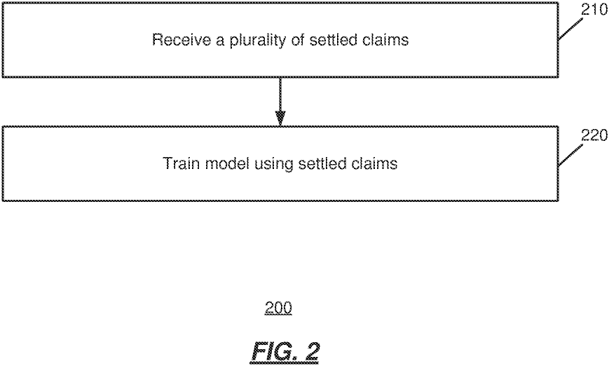

FIG. 2 is an illustration of an example method 200 for training a model 185 to predict the settlement amount for claims 103. The method 200 may be implemented by the disputed claims engine 180 of the clearinghouse 170.

At 210, a plurality of settled claims is received. The plurality of settled claims 120 may be received by the disputed claims engine 180. The settled claims 120 may claims 103 that were previously settled by the clearing house 170 for one or more medical providers 110 and payors 105. Each claim 103 may be a medical claim 103 and may be associated with one or more attributes and a settlement amount.

At 220, a model is trained using the plurality of settled claims. The model 185 may be trained by the disputed claim engine 180 using the settled claims 120. Any method for training a model 185 may be used. The model 185 may take as an input a claim 103 (or attributes of a claim 103) and may output a predicted settlement amount for the claim 103.

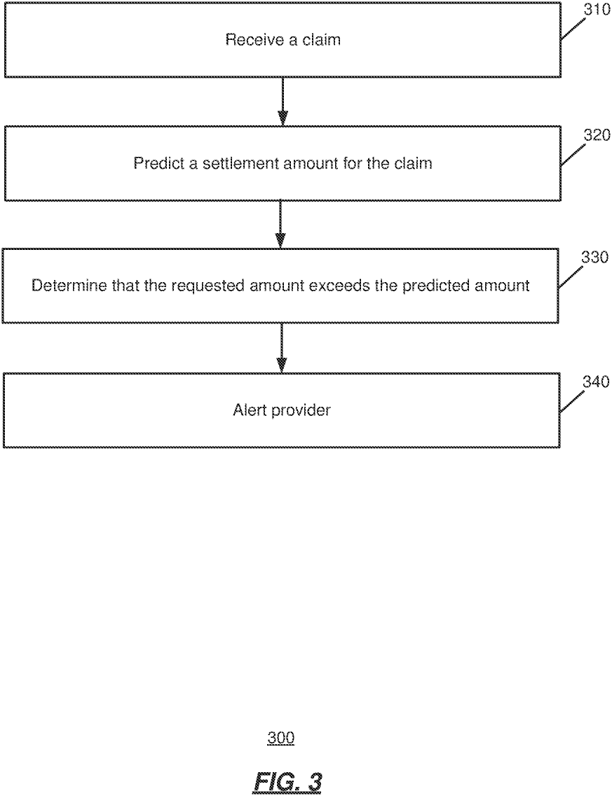

FIG. 3 is an illustration of an example method 300 for alerting a medical provider 110 when a submitted claim 103 has a requested payment amount that exceeds a predicted amount. The method 300 may be implemented by the disputed claims engine 180 of the clearinghouse 170.

At 310, a claim is received. The claim 103 may be received by a clearinghouse 170 from a medical provider 110. The claim 103 may be a medical claim 103 and may be for a medical service provided by the medical provider 110 for a patient. The claim 103 may have attributes and a requested payment amount.

At 320, a settlement amount is predicted for the claim. The settlement amount may be predicted by the disputed claims engine 180 using the model 185 and the attributes associated with the received claim 103.

At 330, that the requested payment amount exceeds the predicted payment amount is determined. The determination may be made by the disputed claims engine 180 comparing the predicted payment amount with the requested payment predicted amount. In some embodiments, the disputed claims engine 180 may determine that the requested payment amount exceeds the predicted payment amount when the amount is exceeded by some threshold amount. The threshold may be a dollar amount threshold (e.g., $100) or may be a percentage threshold (e.g., 20%).

At 340, an alert is provided to the medical provider. The alert may be provided to the medical provider 110 in a same user interface that was used to submit the claim 103. The alert may indicate that the requested payment amount exceeds the predicted payment amount and may recommend that the medical provider 110 reduce the requested payment amount.

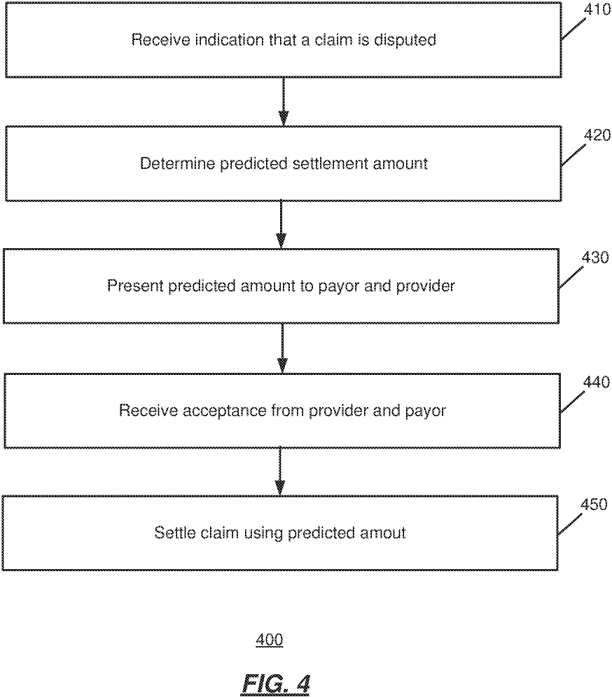

FIG. 4 is an illustration of an example method 400 for settling a disputed claim 103. The method 400 may be implemented by the disputed claims engine 180 of the clearinghouse 170.

At 410, an indication that a claim is disputed is received. The indication may be received by the disputed claims engine 180 from a payor 105. The payor 105 may dispute a claim 103 because the requested payment amount is greater than expected or allowed by the payor 105. Depending on the embodiment, the payor 105 may dispute the claim 103 by selecting the claim 103 using a user interface provided by the disputed claims engine 180 and/or the clearinghouse 170.

At 420, a predicted settlement amount is determined. The predicted settlement amount may be determined by the disputed claims engine 180. The predicted settlement amount is the settlement amount that the claims engine 180 believes that the both the payor 105 and the provider 110 will agree to settle the disputed claim 103 for. In some embodiments, the disputed claims engine 180 may determine the predicted settlement amount using a model 185 that predicts settlement amounts based on attributes of the disputed claim 103. Other method may be used.

At 430, the predicted amount is presented to the payor and the provider. The predicted settlement amount may be presented to the medical provider 110 and the payor 105 as the proposed settlement amount 187 by the disputed claims engine 180. Depending on the embodiment, the proposed settlement amount 187 may be provided to the medical providers 110 and the payor 105 in a user interface or application provided by the clearinghouse 170 and/or the disputed claims engine 180.

At 440, acceptance of the predicted amount is received from both the provider and the payor. The acceptance of the proposed settlement amount 187 may be received from both of the medical provider 110 and the payor 105 by the disputed claims engine 180. Alternatively, the disputed claims engine 180 may receive a counter settlement amount from one or both of the provider 110 and the payor 105. The provider 110 and the payor 105 may exchange counter settlement amounts through the disputed claims engine 180 until agreement on a settlement amount 187 is reached.

At 450, the claim is settled using the predicted amount. The disputed claim 103 may be settled by the clearing house 170 and/or the payor 105. Any method for settling a claim 103 may be used.

FIG. 5 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as random access memory (RAM)), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 408 and non-removable storage 510.

Computing device 500 typically includes a variety of computer readable media. Computer readable media can be any available media that can be accessed by the device 500 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communication connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving an indication that a claim is disputed by a computing device, wherein the claim is associated with a plurality of attributes, a requested payment amount, a payor, and a medical provider;
in response to the determination, determining a predicted settlement amount for the claim based on the attributes associated with the claim;
presenting the predicted settlement amount to the payor and the medical provider by the computing device;
receiving from the payor and the medical provider an acceptance of the predicted settlement amount by the computing device; and
settling the claim for the predicted settlement amount by the computing device.

2. The method of claim 1, further comprising:
storing a plurality of settled claims, wherein each settled claim is associated with a plurality of attributes, and a settlement amount; and
training a model to predict settlement amounts for claims using the stored plurality of settled claims by the computing device.

3. The method of claim 1, further comprising determining the predicted settlement amount for the claim based on the attributes associated with the claim and the model.

4. The method of claim 1, wherein the computing device is associated with a claims clearinghouse.

5. The method of claim 1, further comprising:
receiving a counter settlement amount to the predicted settlement amount from the medical provider;
presenting the counter settlement amount to the payor;
receiving an acceptable of the counter settlement amount from the payor; and
settling the claim for the counter settlement amount.

6. The method of claim 1, further comprising presenting the predicted settlement amount to the payor and the medical provider in a user interface provided by the computing device.

7. A method comprising:
receiving a plurality of settled claims by a computing device, wherein each claim is associated with a plurality of attributes, and a settlement amount by the computing device;
training a model to predict settlement amounts for claims using the stored plurality of settled claims by the computing device;
receiving a claim by the computing device from a provider, wherein the received claim is associated with a plurality of attributes and includes a requested payment amount;
using the attributes associated with the received claim and the model, predicting a settlement amount for the received claim by the computing device;
determining that the requested payment amount exceeds the predicted settlement amount by the computing device; and
in response to the determination, alert the provider that the received claim may be disputed.

8. The method of claim 7, wherein the provider is medical provider.

9. The method of claim 7, wherein the computing device is associated with a claims clearinghouse.

10. The method of claim 7, wherein determining that the requested payment amount exceeds the predicted settlement amount comprises determining that the requested payment amount exceeds the predicted settlement amount by more than a threshold.

11. The method of claim 7, wherein the received claim is received through a user interface, and alerting the provider that the received claim may be disputed in the user interface.

12. The method of claim 7, further comprising recommending that the provider change the requested payment amount to the predicted settlement amount in the alert.

13. The method of claim 7, wherein the plurality of settled claims are claims settled by a medical claim clearinghouse for a plurality of payors and a plurality of medical providers.

14. A system comprising:
at least one computing device; and
a computer-readable medium storing computer executable instructions that when executed by the at least one computing device cause the at least one computing device to:
receive a plurality of settled claims, wherein each claim is associated with a plurality of attributes, and a settlement amount by the computing device;
train a model to predict settlement amounts for claims using the stored plurality of settled claims;
receive a claim from a provider, wherein the received claim is associated with a plurality of attributes and includes a requested payment amount;
using the attributes associated with the received claim and the model, predict a settlement amount for the received claim;
determine that the requested payment amount exceeds the predicted settlement amount; and
in response to the determination, alert the provider that the received claim may be disputed.

15. The system of claim 14, wherein the provider is medical provider.

16. The system of claim 14, wherein the at least one computing device is associated with a claims clearinghouse.

17. The system of claim 14, wherein determining that the requested payment amount exceeds the predicted settlement amount comprises determining that the requested payment amount exceeds the predicted settlement amount by more than a threshold.

18. The system of claim 14, wherein the received claim is received through a user interface, and alerting the provider that the received claim may be subject to the arbitration in the user interface.

19. The system of claim 14, further comprising recommending that the provider change the requested payment amount to the predicted settlement amount in the alert.

20. The system of claim 14, wherein the plurality of settled claims are claims settled by a medical claim clearing house for a plurality of payors and a plurality of medical providers.
